(19) United States
(12) Patent Application Publication
(10) Pub. No.: US 2008/0224444 A1
(43) Pub. Date: Sep. 18, 2008

(54) Command Steer Assembly for an Articulated Vehicle

(75) Inventor: Kerry Atley, Shepparton (AU)

Correspondence Address: BIRCH STEWART KOLASCH & BIRCH, PO BOX 747, FALLS CHURCH, VA, 22040-0747, US

(73) Assignee: TRACKAXLE PTY LTD., Shepparton (AU)

(21) Appl. No.: 11/658,646

(22) PCT Filed: Jul. 29, 2005
(86) PCT No.: PCT/AU05/01131

§ 371 Date: Apr. 26, 2007

(30) Foreign Application Priority Data
Jul. 29, 2004 (AU) 2004904220

(51) Int. Cl. B62D 7/04; B62D 13/02; B62D 7/16; B62D 13/06

(52) U.S. Cl. 280/442

(57) ABSTRACT

A command steer assembly (15) for an articulated vehicle having a prime mover, and at least one trailer body (1) having a sub-chassis (3) rotatable about a main axis (5), the sub-chassis (3) being supported by a plurality of wheel axles, at least one of the wheel axles being steerage, the command steer assembly including: a steer plate (17) supported for rotation about said main axis and interconnectable by a linkage arrangement (13) to the at least one steerable wheel axle; and a drive arrangement (33) for selectively driving the steer plate for rotation, wherein rotation of the steer plate results in pivotal movement of the at least one steerable wheel axle relative to the sub-chassis.

The present invention is generally directed to articulated vehicles and other load carrying vehicles, and in particular to vehicles having steerable axles. Articulated vehicles used for road transport are generally provided with a trailer supported on a plurality of wheel axles to permit the carriage of greater volumes and mass on the trailer.

Devices have been developed to reduce the “off tracking” or “cut in” which limits the trailer's cornering ability, as well as reducing the wear on tyres and road surfaces. Some such devices are known as “steerable axles” where the wheels have a castor action to address some of the cornering issues, while others employ a pivotal sub chassis with a plurality of axles.

A device of the pivotal sub chassis type is described in the Applicant's Australian Patent Application No. 2002223009, details of which are incorporated herein by reference, wherein a sub chassis in the form of a rear carriage attaches proximate to the rear of the trailer body via a turntable, commonly a ballrace. The axles on the rear carriage are actively steered and self-centreing in forward travel. The self steer is actuated by the articulation between the trailer body and the rear carriage, with a linkage arrangement being provided from the trailer body to the rear carriage to oscillating axles on the carriage frame. The steer is achieved by the axle or axles forward of the principal rear axis, oscillating oppositely to the axle or axles rearward from the principal rear axis. Each axle in the system maintains full contribution to the lateral stability of the trailer body.

The articulation of the rear carriage is modified by a fixed stop which prevents it from articulating past a set angle and a resilient variable stop which presents a resistance to the articulation. This resistance reduces as the prime mover towing the trailer body articulates with respect to the trailer. Conversely, as the prime mover returns to alignment with the trailer, the variable stop brings force by resilient means to assist return of the rear carriage to alignment with the trailer body.

In reverse travel the self steer action is the opposite to the forward travel action, so that the rear carriage steers to the limit presented by the fixed stop. This presents difficulty for the driver seeking to reverse the vehicle accurately. This difficulty has been addressed by employing a reversing lock which clamps the carriage frame against rotation and may be selected by the driver to lock the carriage at a particular angle, most frequently in straight alignment.

However, accurate reversing remains difficult for long single trailers, requiring considerable skill on the part of drivers. Furthermore, considerable stress is placed on tyres and suspensions when manoeuvring with axles in locked alignment. This is damaging to the vehicle and to the pavement. Where multi trailer combinations are employed, the reversing problems are multiplied, making some vehicle combinations impossible to reverse.

It is therefore an object of the present invention to overcome or at least minimise the above described reversing problems. With this in mind, the present invention provides a command steer assembly for an articulated vehicle having a prime mover, and at least one trailer body having a sub-chassis rotatable about a main axis, the sub-chassis being supported by a plurality of wheel axles, at least one of the wheel axles being steerable, the command steer assembly including:
a steer plate supported for rotation about said main axis and interconnectable by a linkage arrangement to the at least one steerable wheel axle; and
a drive arrangement for selectively driving the steer plate for rotation, wherein rotation of the steer plate results in pivotal movement of the at least one steerable wheel axle relative to the sub-chassis.

The drive arrangement may be controlled by a driver of the vehicle during reversing of the vehicle. It is however also envisaged that the drive arrangement be controlled by an automatic guidance means, for example including at least one sensor for sensing a preset guideline such as a painted line on the roadway.

A locking arrangement may be provided to lock the steer plate in a preset position when the vehicle is moving in a forward direction.

According to a preferred embodiment of the present invention, the command steer assembly may include a drive plate located at least substantially parallel to and immediately adjacent to the steer plate, the drive plate being rotatable about the same rotational axis as the steer plate and driven by said drive arrangement, and a coupling device for coupling the steer plate to the drive plate when the steer plate is to be driven for rotation. The coupling device may also decouple the steer plate from the drive plate when the steer plate is not required to be driven. The command steer assembly may include a mount plate fixedly secured to the trailer body, and the steer plate may be located immediately adjacent to and at least substantially parallel to the mount plate. The steer plate may therefore be located in a sandwich arrangement between said mount plate and said drive plate. A coupling device may couple the steer plate to the mount plate to lock the steer plate in position relative to the mount plate when the steer plate is not being driven for rotation. The coupling device may include first and second wedge plates, each wedge plate being located at or adjacent opposing ends of a support axle. The support axle may pass through an aperture in the steer plate and extend laterally relative to the steer plate, and an actuator may be provided to oscillate the support axle in a elongate direction of the axle. A cooperating first aperture may be provided in the mount plate within which the first wedge plate may be seated, and a cooperating second aperture may be provided in the drive plate within which the second wedge plate can be supported. Oscillation of the support axle results in the first wedge being located within the first aperture to couple the steer plate to the mount plate in a first position of the support axle of the coupling device, or the second wedge being located within the second aperture to couple the steer plate to the drive plate in a second position of the support axle.

The command steer assembly may further include an alignment device for ensuring that the steer plate is properly aligned with the mount plate to enable coupling thereto and ensure that the link arrangement is properly positioned for forward travel of the vehicle. The alignment device may include an alignment cam arm pivotally connected to the steer plate having a profiled edge for engaging a stub extending from the mount plate. The profiled edge may include a curved guide portion connected to a final retaining portion within which the stub of the steer plate will be accommodated when the steer plate is correctly aligned. The alignment cam arm may be spring loaded or other actuated for movement around a pivot point such that the curved guide potion will urge the stub to a position within the final retaining portion.

The provision of a command steer arrangement according to the present invention enables precise control of the movement of the rear of a trailer of the vehicle facilitating reversing of the vehicle.

The command steering arrangement is applicable for the self steering sub chassis of Australian Patent Application No. 2002223009. The sub-chassis is mounted via a turntable to the trailer body, and is therefore pivotable relative to the trailer. The sub-chassis includes at least one fixed wheel axle and at least one steerable wheel axle. The sub-chassis achieves its steer through the action of steer links mounted to the trailer body in a manner such that they can rotate about the mounting point, and connecting in a similar manner to a rotating member which connects the axles to the sub chassis. Thus the axle directly under the centre of rotation of the sub chassis turntable is fixed to the sub chassis and steer links causes any steerable wheel axles located forward of the centre to rotate with respect to the sub chassis in an opposite direction to any steerable wheel axles located to the rear.

According to the present invention, the steer links may be mounted to the steer plate which can rotate about its centre, which is coincident with the centre of rotation of the sub chassis turntable. During forward travel, the coupling arrangement may secure this steer plate in fixed relationship to the trailer body, but in reverse the plate can be rotated to impart a command steer by rotating the forward and rearward axles oppositely, creating a steer pattern which directs the sub chassis. This rotation can be imparted by means of a linear actuator (electric, hydraulic, or pneumatic), or by engagement of a gear which might connect to an electric or hydraulic motor. This rotation is actuated respective to the sub chassis and is controlled by the driver using an electrical control in the prime mover.

In the preferred arrangement of the sub-chassis, there are three axles, the centre axle being fixed to the sub chassis. However the axle arrangements are not limited to this, with various numbers of axles forward and rearward of the rotation centre being possible. It is further possible that the rotating plate may have only one steer link connected to a first axle and other axles move in response to the rotation of this first axle.

It will be convenient to further describe the invention with respect to the accompanying drawings which illustrate preferred embodiments of the command steer assembly for an articulated vehicle according to the present invention. Other embodiments of the invention are possible, and consequently, the particularity of the accompanying drawings is not to be understood as superceding the generality of the preceding description of the invention.

In the drawings:

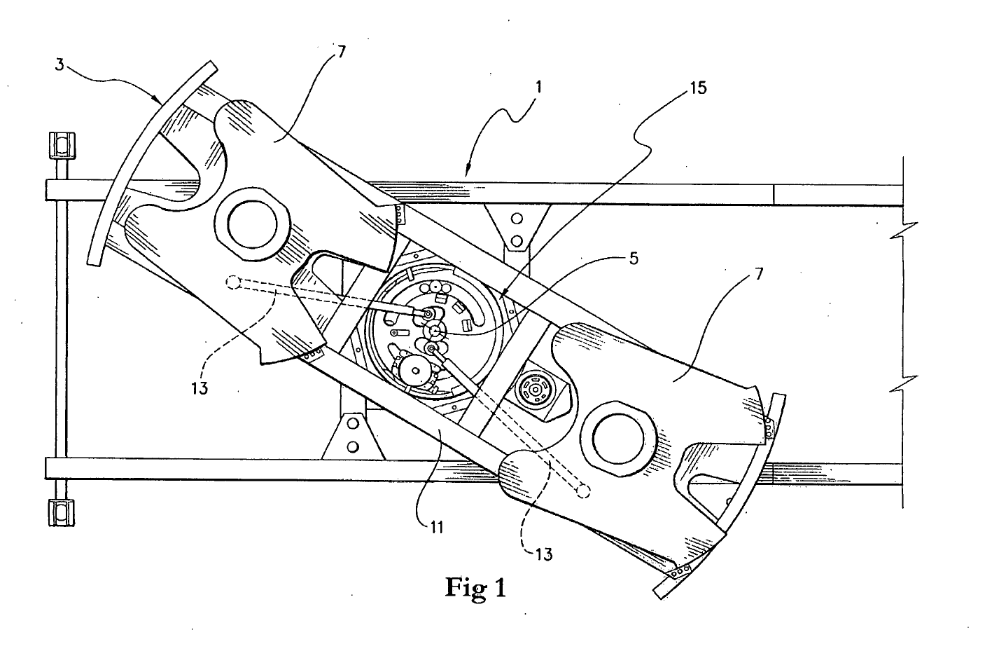

FIG. 1 is a bottom view of a sub-chassis of a trailer incorporating the command steer assembly according to the present invention;

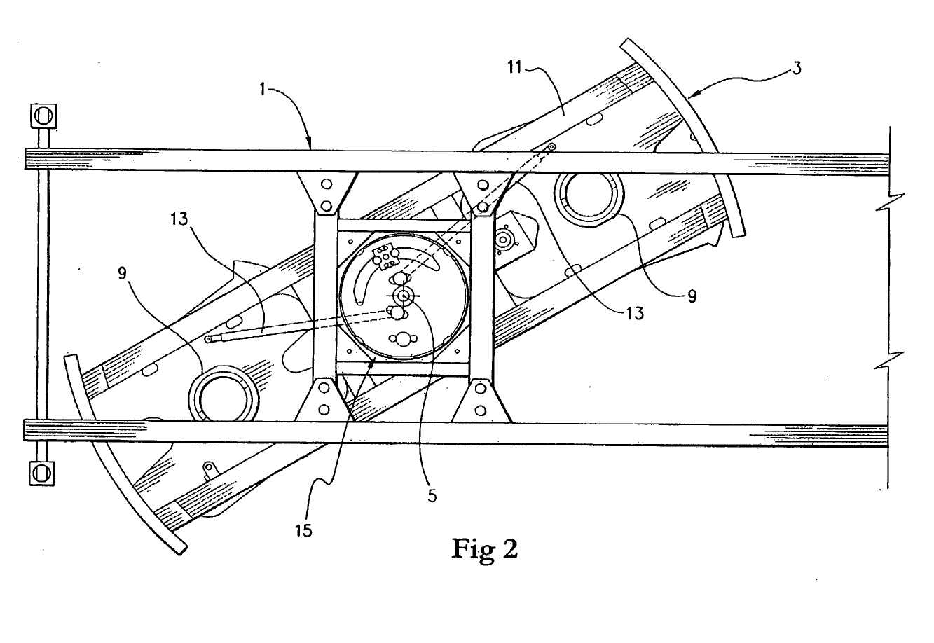

FIG. 2 is a top view of the trailer sub-chassis according to FIG. 1;

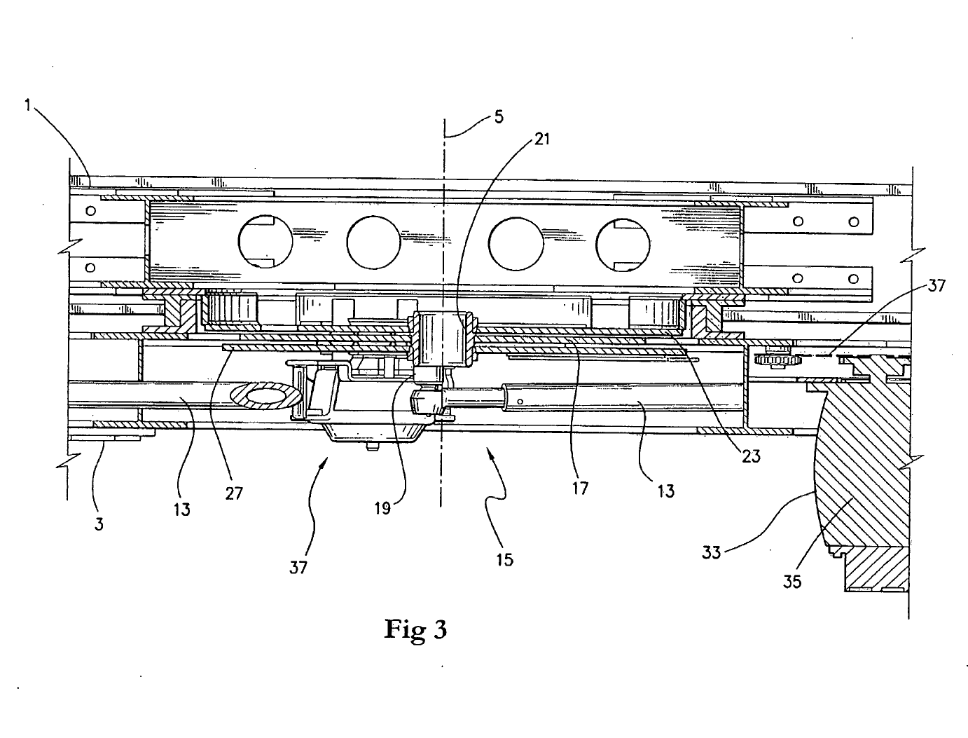

FIG. 3 is a detailed cross-sectional view of the command steer assembly as shown in FIGS. 1 and 2;

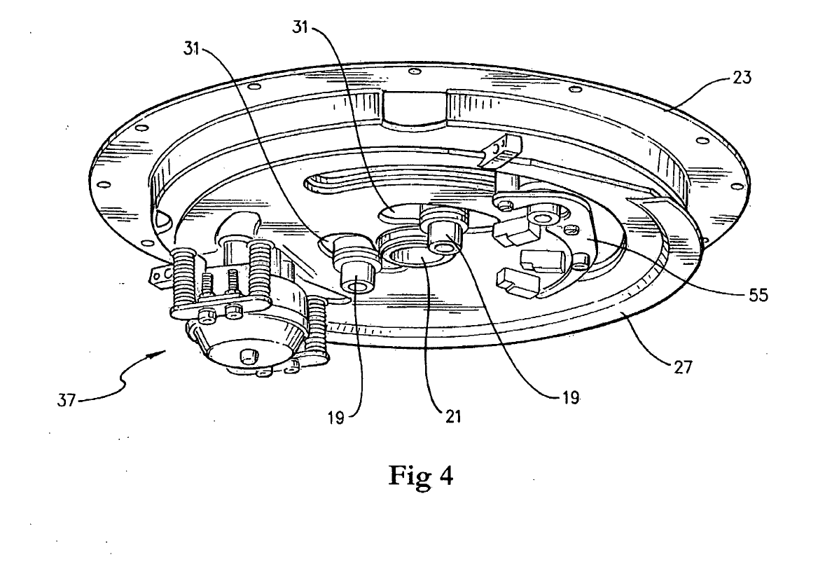

FIG. 4 is a perspective view of another embodiment of a command steer assembly according to the present invention; and

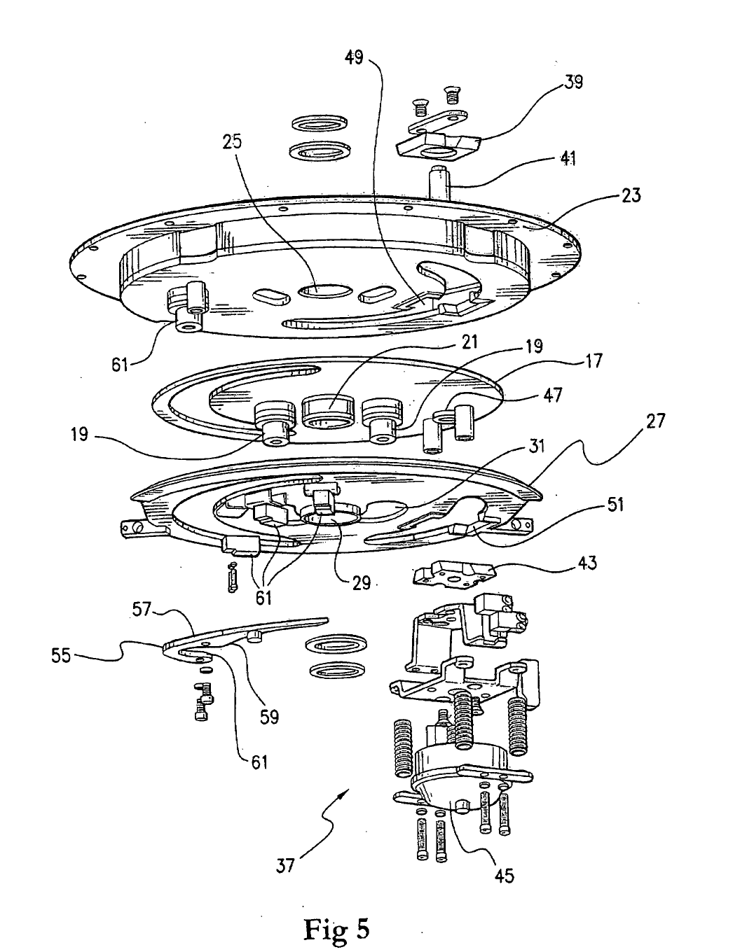

FIG. 5 is an exploded view of the command steer assembly of FIG. 4.

Referring initially to FIGS. 1 and 2, the present invention is particularly applicable for a trailer body 1 having a rotatable sub-chassis 3 which is rotatable about a generally vertically aligned main axis 5. The sub-chassis 3 supports the wheel axles, which are not shown in the drawings to ensure that the key components of the present invention are more clearly shown. Steerable wheel axles can be supported using conventional suspension arrangements upon rotatable support plate 7 provided at opposing ends of the sub-chassis 3, each support plate being supported by a ballrace 9 to the main frame 11 of the sub-chassis 3. A fixed wheel axle can also be mounted using conventional suspension arrangements to the sub-chassis mainframe 11 at a position between the two support plates 7.

Each support plate 7 is connected by a steer link 13 to a command steer assembly 15 according to the present invention.

FIG. 3 shows in more detail the various components of the command steer assembly 15 according to the present invention. FIGS. 4 and 5 show an alternative embodiment of the command steer assembly 15, which is, however, almost identical to the command steer assembly embodiment shown in FIG. 3. Both embodiments will therefore be described together. Each steer link 13 is connected to a steer plate 17 via a pivotal shaft arrangement 19 extending laterally from the steer plate 17. The steer plate 17 is rotatable about the main axis 5 by means of a cylindrical bearing 21. Each pivotal shaft arrangement 19 of each steer link 13 is offset relative to the main axis 5 as best shown in FIGS. 1 and 2. Rotation of the steer plate 17 therefore results in the opposing support plates 7 rotating at equal but opposite angles thereby facilitating the steering of the sub-chassis wheel axles.

The cylindrical bearing 21 allows the steer plate 17 to be pivotally supported on a mount plate 23, with the cylindrical bearing 19 being accommodated with a central aperture 25 provided in the mount plate 23. The mount plate 23 is fixedly secured to the trailer body 1. The cylindrical bearing 21 also supports a drive plate 27 via a central aperture 29 within the drive plate 27. The steer plate 17 is therefore sandwiched between the mount plate 23 and the drive plate 27 as best shown in FIG. 3 and 5. Curved apertures 31 are also provided within the drive plate 27 to provide clearance through which the pivotal shaft arrangement 19 for the steer links 13 can extend.

The drive plate 27 is driven for rotation by a drive arrangement 33. The drive arrangement shown in FIG. 3 includes an electric or hydraulic motor 35 connected via a chain wheel assembly 37 to the drive plate 27.

The steer plate 17 can be alternatively coupled to the mount plate 23 or to the drive plate 27. This is achieved by means of a coupling arrangement 37 as best shown in FIG. 5. This coupling arrangement includes a first wedge plate 39 supported on one end of a support axle 41. A second wedge plate 43 is supported at the opposing end of the support axle 41. A hydraulic or pneumatic actuator 45 acts to oscillate the support axle 41 in an elongate direction of the support axel 41. The support axle 41 extends through an aperture 47 provided in the steer plate 17. The first wedge plate 39 can cooperate with a square aperture 49 provided in the mount plate 23. The second wedge plate 43 can cooperate with a second square aperture 51 provided within the drive plate 27. When the vehicle is moving in a forward direction, the steer plate 17 will be coupled with the mount plate 23 and therefore fixed relative to said mount plate 23. A series of springs (not shown) normally urge the first wedge plate 39 into the square aperture 49 of the mount plate, while the second wedge plate 43 is disengaged from the second square aperture 51 provided in the drive plate 27. When the vehicle is required to reverse, and it is necessary to provide direct control of the steering of the rear axels, the actuator 45 urges the second wedge plate 43 into the square aperture 51 of the drive plate 27. At the same time, the first wedge plate 39 is disengaged from the square aperture 49 of the mount plate 23. This effectively couples the steer plate 17 to the drive plate 27 thereby allowing for direct steering of the steer plate 17. This ensures the precise control of the steerable axles of the sub-chassis 3 when the vehicle is reversing.

When the vehicle is required to move in a forward direction, the actuator deactivates to allow the first wedge plate 39 to again seat within the square aperture 49 of the mount plate 23 while at the same time allowing for disengagement of the second wedge member 43 from the square aperture 51 of the drive plate 27. If the steer plate 17 is not properly aligned with the mount plate 23, then it will not be possible for the first wedge plate 39 to engage the mounting plate square aperture 49. An alignment device 55 is therefore provided to ensure that the steer plate 17 is properly aligned with the mount plate 23. This alignment device 55 includes an alignment cam arm 57 pivotally connected to the steer plate 17. The alignment cam arm 57 has profiled edge including a curved guide portion 59 connected to a final retaining portion 61. Resilient means “not shown” act to urge the alignment cam arm 55 against the stub 61 such that the stub will move towards and be retained within the final retaining portion 61 as best shown in FIG. 4. This ensures that the steer plate 17 is properly aligned with the mount late 23 therefore ensuring that the first wedge plate 39 properly engages the mount plate square aperture 49. A series of sensors 61 are mounted on the drive plate 27 adjacent the alignment cam arm 55 to ascertain its location.

Modifications and variations as would be deemed obvious to the person skilled in the art are included within the ambit of the present invention as claimed in the appended claims. For example, the drive arrangement may alternatively be provided by a linear actuator or by a gear drive. Furthermore, the drive arrangement may be controlled directly by a driver of the vehicle or automatically by means of an automatic guide means.

1. A command steer assembly for an articulated vehicle having a prime mover, and at least one trailer body having a sub-chassis rotatable about a main axis, the sub-chassis being supported by a plurality of wheel axles, at least one of the wheel axles being steerable, the command steer assembly including:
a steer plate supported for rotation about said main axis and interconnectable by a linkage arrangement to the at least one steerable wheel axle; and
a drive arrangement for selectively driving the steer plate for rotation, wherein rotation of the steer plate results in pivotal movement of the at least one steerable wheel axle relative to the sub-chassis.

2. A command steer assembly according to claim 1, wherein the drive arrangement is controlled by a driver of the vehicle during reversing of the vehicle.

3. A command steer assembly according to claim 1 or 2, further including a locking arrangement for locking the steer plate in a preset position relative to the trailer body when the vehicle is moving in the forward direction.

4. A command steer assembly according to claim 1 or 2, wherein the command steer assembly includes a drive plate located at least substantially parallel to and immediately adjacent to the steer plate, the drive plate being rotatable about the same rotational axis as the steer plate and driven by said drive arrangement, and a coupling device for coupling the steer plate to the drive plate when the steer plate is to be driven for rotation.

5. A command steer assembly according to claim 4 further including a mount plate fixedly secured to the trailer body, with the steer plate being located immediately adjacent to and at least substantially parallel to the mount plate such that the steer plate is located in a sandwich arrangement between said mount plate and said drive plate, and a coupling device for coupling the steer plate to the mount plate to lock the steer plate in position relative to the mount plate when the steer plate is not being driven for rotation.

6. A command steer assembly according to claim 5, wherein the coupling device includes first and second wedge plates, each wedge plate being located at or adjacent opposing ends of a support axle, the support axle passing through an aperture in the steer plate and extending laterally relative to the steer plate, and an actuator for oscillating the support axle in a elongate direction of the axle, a cooperating first aperture being provided in the mount plate within which the first wedge plate may be seated, and a cooperating second aperture being provided in the drive plate within which the second wedge plate can be supported, wherein oscillation of the support axle results in the first wedge being located within the first aperture to couple the steer plate to the mount plate in a first position of the support axle of the coupling device, or the second wedge being located within the second aperture to couple the steer plate to the drive plate in a second position of the support axle.

7. A command steer assembly according to claim 5, further including an alignment device for ensuring that the steer plate is properly aligned with the mount plate to enable coupling thereto and ensure that the link arrangement is properly positioned for forward travel of the vehicle.

8. A command steer assembly according to claim 7, wherein the alignment device includes an alignment cam arm pivotally connected to the steer plate having a profiled edge for engaging a stub extending from the mount plate, the profiled edge including a curved guide portion connected to a final retaining portion within which the stub of the steer plate will be accommodated when the steer plate is correctly aligned, the alignment cam arm being urged for movement around a pivot point such that the curved guide portion will urge the stub to a position within the final retaining portion.

9. A trailer for an articulated vehicle including a sub-chassis rotatable about a main axis, the sub-chassis being supportable by a plurality of wheel axles, at least one of the wheel axles being steerable, the trailer including a command steer assembly as claimed in claim 1.
